(19) United States
(12) Patent Application Publication
(10) Pub. No.: US 2010/0226225 A1
(43) Pub. Date: Sep. 9, 2010

(54) DATA REPRODUCTION DEVICE

(76) Inventors: Naoyuki Kashii, Osaka (JP); Shiro Shimizu, Osaka (JP)

Correspondence Address: WENDEROTH, LIND & PONACK L.L.P., 1030 15th Street, N.W., Suite 400 East, Washington, DC, 20005-1503, US

(21) Appl. No.: 11/997,232

(22) PCT Filed: Jul. 26, 2006
(86) PCT No.: PCT/JP2006/314811

§ 371 Date: Jan. 29, 2008

(30) Foreign Application Priority Data
Jul. 29, 2005 (JP) 2005-219952

(51) Int. Cl. G11B 20/10

(52) U.S. Cl. 369/47.32; G9B/20.009

(57) ABSTRACT

The writing in of the reproduced data from the optical disc 101 or the reproduced data from the external USB device 103 into the memory 106 is carried out in such a manner that the data storage formats on the memory 106 of the both writing in are the same storage formats with each other, and the writing in control into the memory 106 and reading out control from the memory 106 are carried out by the similar methods with each other. Thereby, in a data reproduction method having a function of reproducing data which is recorded in the optical disc 101 and a function of reproducing data from an external USB device, a reproduction device which provides no complicated control method as well as gives no large load to the system and is of a high efficiency can be provided.

### TECHNICAL FIELD

The present invention relates to a data reproduction device, and more particularly, to that which has a function of efficiently reproducing data from an external device or an external medium other than a disc such as an USB device or an SD memory.

### BACKGROUND ART

FIG. 10 is a diagram illustrating a conventional data reproduction device which reproduces data which is recorded in an optical disc.

In the figure, the conventional data reproduction device 1000 includes an optical pickup 1002 which collects a light beam onto an information surface of an optical disc 1001 in which information symbols are recorded on spiral or concentric tracks to form a light beam spot and detects the reflected light to output respective kinds of information, a disc reading out part 1003 for reading out reproduced data on the basis of the information which is outputted from the optical pickup 1002, a memory 1004 for temporarily storing the data reproduced from the optical disc 1001 for anti-earthquake use at performing reproduction from the disc, a writing in control part 1005 for writing in the reproduced data which is readout by the disc reading out part 1003 into the memory, and a reading out control part 1006 for reading out the reproduced data from the memory 1004.

In the data reproduction device constructed as described above, in order to read out reproduced data from a medium other than a disk, a data transfer device which is connected via an optical cable (not illustrated) and has mounted a controller for an external medium (for example, refer to patent document 1) is employed. The data transfer unit is equipped with a controller for transferring the reproduced data from the external medium to an audio device, and the data reproduction device carries out reproduction of data which is temporarily continuous from the external medium, with the data passing through the data transfer device.

To the contrary, as data reproduction devices for reading the data recorded on a disk such as CD or DVD, devices which can carry out reading out of also the reproduced data from a medium other than a disc has been requested.

Patent document 1: Japanese Published Patent Application No. 2002-91896

### DISCLOSURE OF THE INVENTION

### Problems to be Solved by the Invention

In the conventional data reproduction device, in order to reproduce data from an external medium, a construction in which data is reproduced with passing through a data transfer device is provided as described above. Further, in a data reproduction device which carries out reading of data which was recorded on a disc such as CD or DVD, in order to enable even reading out of the reproduced data from an external medium, it is required to additionally provide a data reproduction device that performs reproduction of data from a disc with a data reproduction device that performs reproduction of data from an external medium, resulting in inefficiency in handling.

Further, in a microcomputer that carries out a reproduction control, both of reproduction control from a disc such as CD or DVD and reproduction control from an external medium have to be carried out, thereby resulting in a heavier load.

The present invention is directed to solving the above-described problems and has for its object to provide a data reproduction device that can efficiently add a reproduction device which reproduces data from an external medium to a data reproduction device which reproduces data from a disc such as CD or DVD.

### Measures to Solve the Problems

In order to solve the above-described problems, according to Claim 1 of the present invention, there is provided a data reproduction device which has a function of reproducing data which is recorded in a disc medium, and a function of reproducing data which is recorded in an external medium other than the disc medium or reproducing data from an external device, comprising: a disc reading out part for reading out data which is recorded in the disc medium, an external data taking in part for taking in data from the external medium or the external device, a memory for temporarily storing the reproduced data from the disc medium which was read out by the disc reading out part, or the reproduced data from the external medium or the external device which has been taken in by the external data taking in part, a writing in control part for writing in the reproduced data from the disc medium which is read out by the disc reading out part, or the reproduced data from the external medium or the external device which has been taken in by the external data taking in part into the memory, and a reading out control part for reading out the reproduced data which has been written in into the memory, wherein the writing in control part carries out the writing in of the reproduced data from the disc medium or the reproduced data from the external medium or the external device into the memory in such a manner that the data storage formats on the memory while performing the both writing in are the same storage formats with each other.

According to Claim 2 of the present invention, there is provided a data reproduction device as defined in Claim 1 wherein the writing in control part writes in only the user data in the format of compressed data when performing writing in of the reproduced data into the memory in a case where the reproduced data which was recorded in the external medium or the external device is in the format of compressed data, and there is provided a compression decoder which decodes the compressed data, when the compressed data is read out from the memory in which the compressed data is written in, to output the decoded data as reproduced data.

According to Claim 3 of the present invention, there is provided a data reproduction device which has a function of reproducing data which is recorded in a disc medium, and a function of reproducing data which is recorded in an external medium other than the disc medium, or reproducing data from an external device, comprising: a disc reading out part for reading out data which is recorded in the disc medium, an external data taking in part for taking in data from the external medium or the external device, a memory for temporarily storing the reproduced data from the disc medium which was read out by the disc reading out part, or the reproduced data from the external medium or the external device which has been taken in by the external data taking in part, a writing in control part for writing in the reproduced data from the disc medium which is read out by the disc reading out part, or the reproduced data from the external medium or the external device which has been taken in by the external data taking in part into the memory, a reading out control part for reading out the reproduced data which has been written in into the memory, and a data judging part which judges the read out data from the disc reading out part and the reproduced data from the external deice or the external medium when reading out the reproduced data which was written in into the memory, wherein the reading out control part carries out the reading out of the data with selecting only the required user data when the data to read out is judged as the reproduced data from the external device or the external medium by the data judging part.

According to Claim 4 of the present invention, there is provided a data reproduction device as defined in claim 3, wherein the writing in control part writes in the reproduced data from the disc medium or the reproduced data from the external medium or the external device with containing an identification information for the reproduced data in the reproduced data, and the reading out control part carries out reading out of the reproduced data in accordance with the judgment result as to whether the reproduced data that is judged on the basis of the identification information is the reproduced data from the disc medium or the reproduced data from the external medium or the external device.

### EFFECTS OF THE INVENTION

According to a first aspect of the present invention, since a data reproduction device has a function of reproducing data which is recorded in a disc medium, and a function of reproducing data which is recorded in an external medium other than the disc medium or reproducing data from an external device, includes a disc reading out part for reading out data which is recorded in the disc medium, an external data taking in part for taking in data from the external medium or the external device, a memory for temporarily storing the reproduced data from the disc medium which was read out by the disc reading out part, or the reproduced data from the external medium or the external device which has been taken in by the external data taking in part, a writing in control part for writing in the reproduced data from the disc medium which is read out by the disc reading out part, or the reproduced data from the external medium or the external device which has been taken in by the external data taking in part into the memory, and a reading out control part for reading out the reproduced data which has been written in into the memory, and the writing in control part carries out the writing in of the reproduced data from the disc medium or the reproduced data from the external medium or the external device into the memory in such a manner that the storage formats of data on the memory while performing the both writing in are the same storage formats with each other, the writing in control part can be commonly used and a circuit of high efficiency can be provided.

Further, since when the data recorded in an external medium is reproduced or data is reproduced from an external device, it is possible to realize the reproduction by an equivalent control to that at performing data reproduction from the disc medium, and thereby the control by the microcomputer can be easily realized, as well as reduction in the load can be realized.

According to a second aspect of the present invention, since in a data reproduction device as defined in claim 1, the writing in control part writes only the user data in the format of compressed data when performing writing in of the reproduced data into the memory in a case where the reproduced data which was recorded in the external medium or the external device is in the format of compressed data, and a compression decoder which decodes the compressed data, when the compressed data is read out from the memory in which the compressed data is written in, to output the decoded data as the reproduced data, is provided, it is possible to carry out reproduction of compressed audio data from the memory by an equivalent control to that at performing data reproduction from the disc medium, and thereby, the control by the microcomputer can be easily realized, as well as reduction in the load can be realized.

According to a third aspect of the present invention, since a data reproduction device which has a function of reproducing data which is recorded in a disc medium, and a function of reproducing data which is recorded in an external medium other than the disc medium, or reproducing data from an external device, includes a disc reading out part for reading out data which is recorded in the disc medium, an external data taking in part for taking in data from the external medium or the external device, a memory for temporarily storing the reproduced data from the disc medium which was read out by the disc reading out part, or the reproduced data from the external medium or the external device which has been taken in by the external data taking in part, a writing in control part for writing in the reproduced data from the disc medium which is read out by the disc reading out part, or the reproduced data from the external medium or the external device which has been taken in by the external data taking in part into the memory, a reading out control part for reading out the reproduced data which has been written in into the memory, and a data judging part which judges the read out data from the disc reading out part and the reproduced data from the external device or the external medium when performing reading out of the reproduced data which was written in into the memory, and the reading out control part carries out the reading out of the data with selecting only the required user data when the data to be read out is judged as the reproduced data from the external device or the external medium by the data judging part, the reproduced data from the external medium or the external device can be directly transferred to the memory as it is, thereby easing the writing in control by the writing in control part. Further, in a system which carries out the reading out control by another processor, the writing in control can be carried out with the load to the microcomputer performing the writing in control shared with the other processor, thereby providing a system of high efficiency.

According to a fourth aspect of the present invention, since in a data reproduction device as defined in claim 3, the writing in control part writes in the reproduced data from the disc medium or the reproduced data from the external medium or the external device with containing an identification information for the reproduced data in the reproduced data, and the reading out control part carries out reading out of the reproduced data in accordance with the judgment result as to whether the reproduced data that is judged on the basis of the identification information is the reproduced data from the disc medium or the reproduced data from the external medium or the external device, it is possible to easily carry out the judgment of the reproduced data by the reading out control part, and thereby, the load to the reading out control can be reduced.

### BRIEF DESCRIPTION OF THE DRAWINGS

FIG. 1 is a diagram illustrating a construction of a data reproduction device according to a first embodiment of the present invention.

FIG. 2 is a diagram illustrating the format of data which is reproduced from the data reproduction device according to the first embodiment of the present invention.

FIG. 3 is a diagram illustrating the format of data which is stored in a memory from the writing in control part in the data reproduction device according to the first embodiment of the present invention.

FIG. 4 is a block diagram illustrating a construction of a data reproduction device according to a second embodiment of the present invention.

FIG. 5 is a diagram illustrating the format of data which is reproduced from the data reproduction device according to the second embodiment of the present invention.

FIG. 6 is a block diagram illustrating a construction of a data reproduction device according to a third embodiment of the present invention.

FIG. 7 is a diagram illustrating the format of data which is reproduced from the data reproduction device according to the third embodiment of the present invention.

FIG. 8 is a block diagram illustrating a construction of a data reproduction device according to a fourth embodiment of the present invention.

FIG. 9 is a diagram illustrating the format of data which is stored in a memory from the writing in control part in the data reproduction device according to the fourth embodiment of the present invention.

FIG. 10 is a diagram illustrating a construction of a prior art data reproduction device.

### DESCRIPTION OF REFERENCE NUMERALS

100, 400, 600, 800 . . . data reproduction device
101, 401, 601, 801 . . . optical disc
102, 402, 602, 802 . . . optical pickup
103, 403, 603, 803 . . . USB device
104, 404, 604, 804 . . . disc reading out part
105, 405, 605, 805 . . . external data taking in part
106, 406, 606, 806 . . . memory
107, 407, 607, 807 . . . writing in control part
108, 408, 608, 808 . . . reading out control part
409, 609, 809 . . . compression decoder
610, 810 . . . data judging part
901 . . . header part
902 . . . information indicating the mode in a header
1000 . . . data reproduction device
1001 . . . optical disc
1002 . . . optical pickup
1003 . . . disc reading out part
1004 . . . memory
1005 . . . writing in control part
1006 . . . reading out control part

### BEST MODE FOR CARRYING OUT THE INVENTION

Hereinafter, embodiments of the present invention will be described with reference to the drawings.

### First Embodiment

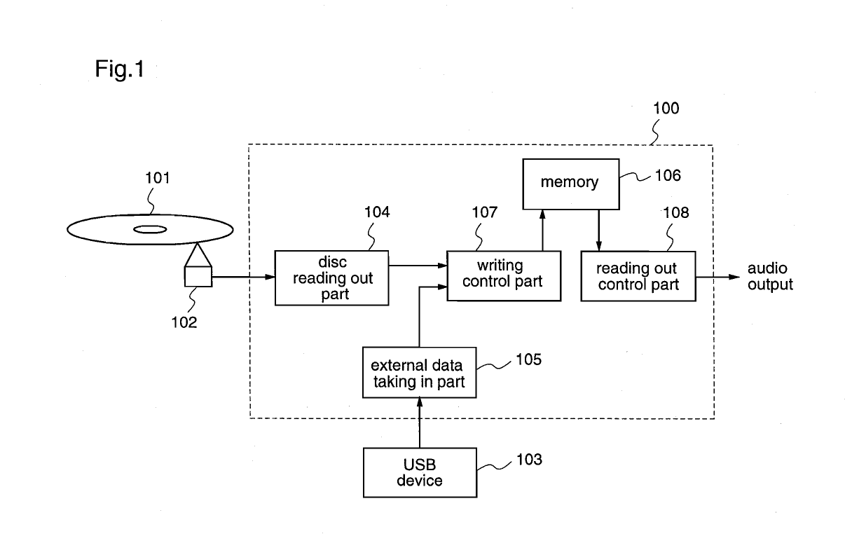

FIG. 1 shows a block construction diagram illustrating a data reproduction device according to a first embodiment of the present invention.

In FIG. 1, the data reproduction device 100 according to the first embodiment of the present invention includes an optical pickup 102 which collects a light beam onto an information surface of an optical disc (disc medium) 101 in which information symbols are recorded on spiral or concentric tracks to form a light beam spot and detects the reflected light to output respective kinds of information, an external USB device 103 in which audio reproduced data is stored, a disc reading out part 104 for reading out reproduced data on the basis of the information which is outputted from the optical pickup 102, an external data taking in part 105 for taking in the reproduced data from the external USB device (external device), a memory 106 for temporarily storing the data reproduced from the optical disc 101 or the data reproduced from the external USB device 103 for anti-earthquake use at performing disc reproduction, a writing control part 107 for performing a writing in control with switching as input the data reproduced from the disc reading out part 104 and the data reproduced from the external data taking in part 105 such that the data storage formats onto the memory 106 are the same storage formats with each other, and a reading out control part 106 for reading out the reproduced data from the memory 106.

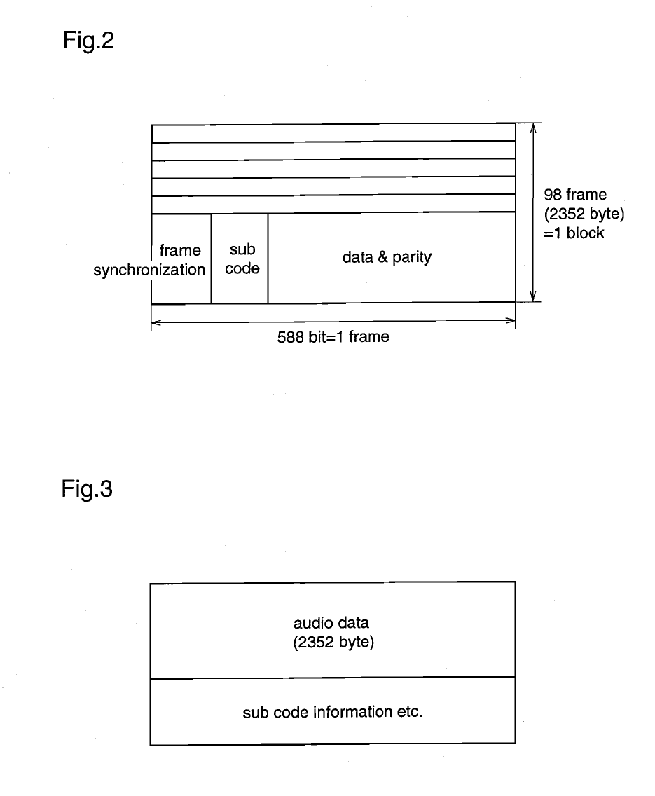

In the data reproduction device 100 of this first embodiment, the reproduced data which are read out from the optical disk 101 and the external USB device 103 are supposed to be in a CD format. The sector construction in the CD-DA format is provided as shown in FIG. 2 such that one which is constituted by a synchronization pattern, sub-code, data, and parity, totally amounting to 588 bits produces a frame, the data of 98 frames constitute a block unit, and the data of 2352 bytes constitute one block.

Further, the writing in control part 107 stores, when storing the reproduced data in a CD-DA format from the optical disc 101 or from the external USB device 103 into the memory 106, the data of one block unit with such as sub-code information which is included in the audio data being separately added to the audio data of 2353 bytes shown in FIG. 2, as illustrated in the data storage format in the memory 106 of one block unit as shown in FIG. 3, into the memory 6.

Next, the operation of the data reproduction device according to the first embodiment will be described.

First, the operation of reproducing data from the optical disc 101 which has recorded data in a CD-DA format will be described.

In the optical disc 101, the data is recorded in a block unit as shown in FIG. 2, and the output data from the pickup 102 is read out as reproduced data by the disc reading out part 104, and the reproduced data is sent out to the writing in control part 107. The writing in control part 107 which has received the reproduced data carries out, when performing reproduction of the optical disc 101, a control such that the data from the disc reading out part 104 is stored into the memory 106. Meanwhile, the writing in control part 107 converts, in order to ease the reading out control, the data of the format illustrated in FIG. 2 to the data of the format illustrated in FIG. 3, and writes in the reproduced data after its format being converted into the memory 106. The data which is written in into the memory 106 is read out by the reading out control part 108, to be outputted as an audio output.

Next, the operation of reproducing the data in a CD-DA format from the external USB device 103 will be described.

The external USB device 103 has recorded data in a block unit constituted as illustrated in FIG. 2 similarly as the disc 101, and the reproduced data is taken in by the external data taking in part 105, to be sent out to the writing in control part 107. The writing in control part 107 which has received the reproduced data carries out a control, when performing reproduction of data from the external USB device 103, such that the data from the external data taking in part 105 is stored into the memory 106. Meanwhile, the writing in control part 107 converts, in order to ease the reading out control, the data format illustrated in FIG. 2 to the format illustrated in FIG. 3 similarly at performing reproduction of the optical disk 101, and writes in the reproduced data in the converted format into the memory 106. The data which was written in into the memory 106 is read out by the reading out control part 108, to be outputted as audio output.

As described above, according to the reproduction device of the first embodiment, the writing in of the reproduced data from the optical disc 101 or the reproduced data from the external USB device 103 into the memory 106 is carried out by the writing in control part 107 such that the data storage formats on the memory 106 at performing the both writing in are the same storage formats with each other. Therefore, when realizing a data reproduction device having a function of reproducing data from the optical disc 101 and a function of reproducing data from the external USB device 103, the writing in control part can be made common for the both writing in, and thereby the circuit can be made of high efficiency. In addition, since the writing in control part 107 carries out writing in of the reproduced data from the optical disc 101 and writing in of the reproduced data from the external USB device 103 into the memory 106 such that the data storage formats on the memory 106 are the same storage formats with each other as illustrated in FIG. 3, the reading out control by the reading out control part 108 can also be carried out by similar methods at performing reproduction from the optical disk 101 and at performing reproduction from the external USB device 103. Since the writing in control and the reading out control can be carried out by similar methods for the data from the optical disc 101 and for the data from the external device, the load applied to the microcomputer that controls the whole system can be reduced, and thereby, a data reproduction device having a function of reproducing data from the optical disc 101 and a function of reproducing data from the external USB device 103 can be easily realized.

While in the above-described first embodiment an example in which an external USB device is employed is described, it is not limited thereto. That is, the present invention can be realized by a memory device including other storage medium (external medium) such as an SD memory card.

Further, while in the first embodiment the reproduction of CD-DA audio data is described, the reproduced of other format data such as reproduction of CD-ROM data can be employed with the same effects as described above.

Further, while in the above-described first embodiment an example in which an optical disc is employed as a disc medium is described, a data reproduction device such as employing an optical magnetic disc or a magnetic disc can be constructed with the same effects as described above.

### Second Embodiment

A data reproduction device 400 according to the second embodiment of the present invention is a data reproduction device which can reproduce the data in the optical disc 401 which are recorded in such as a CD-DA format or a CD-ROM format and has a function of reproducing data from an optical disc and a function of reproducing data from an external USB device, and further, which, in order to enhance the efficiency of the circuit, carries out writing in of the reproduced data from the optical disc into the memory as well as writing in of the data from the external USB device into the memory by similar methods.

Next, the data reproduction device according to the second embodiment of the present invention will be described.

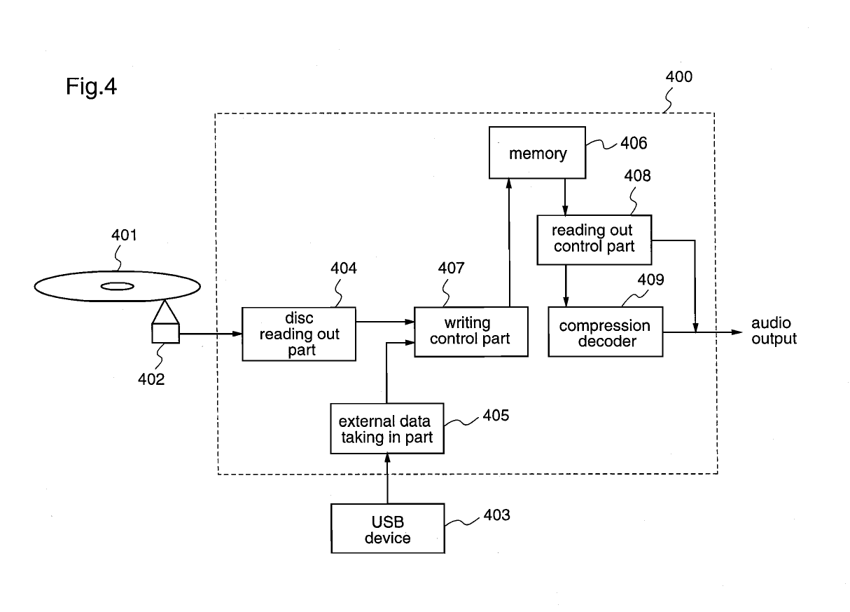

FIG. 4 is a block construction diagram illustrating the data reproduction device according to the second embodiment of the present invention.

In FIG. 4, the reproduction device 400 of this second embodiment includes an optical pickup 402 which collects a light beam onto an information surface of an optical disc (disc medium) 401 in which information symbols are recorded on spiral or concentric tracks to form a light beam spot and detects the reflected light to output respective kinds of information, an external USB device (external device) 403 in which data in a CD-DA format or data in a CD-ROM format (compressed audio data) are stored, a disc reading out part 404 for reading out reproduced data on the basis of the information which is outputted from the optical pickup 402, an external data taking in part 405 for taking in the reproduced data from the external USB device 403, a memory 406 for temporarily storing the data reproduced from the optical disc 401 or the data reproduced from the external USB device 403 for anti-earthquake use at performing reproduction from the disc, a writing in control part 407 for performing a control for writing of data into a memory with switching as input the reproduced data from the disc reading out part 404 and the reproduced data from the external data taking in part 405 so that the data storage formats on the memory 406 are the same storage formats with each other, a reading out control part 408 for reading out the reproduced data from the memory 406, and a compression decoder 409 which makes the compressed audio data subjected to decoding processing to output the result as an audio data.

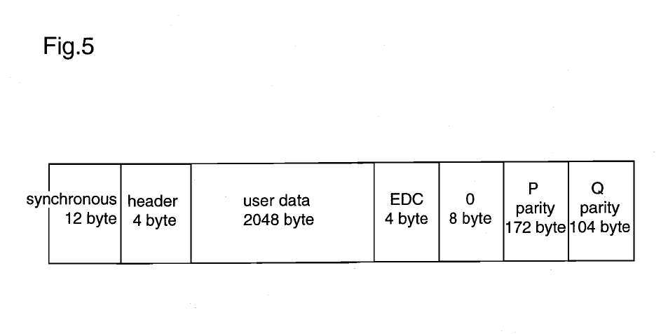

In the data reproduction device of the second embodiment, the reproduced data which is read out from the optical disc 401 and from the external USB device 403 are supposed as data in a format of CD-DA format or in a format of the CD-ROM format. The CD-DA format is of the same construction as that shown in FIG. 2, and the CD-ROM format is a format of CD-ROM model as shown in the format of one sub coding frame shown in FIG. 5.

Further, the writing control part 407 stores, when storing the reproduced data in a CD-DA format from the optical disc 401 or from the external USB device 403 into the memory 406, the data of one block unit with such as sub-code information which is included in the audio data being separately added to the audio data of 2352 bytes shown in FIG. 2, as illustrated in the data storage format in the memory 406 of one block unit as shown in FIG. 3, into the memory 406.

Further, the writing in control part 407 makes, when storing the reproduced data in a CD-DA format from the optical disc 401 or the external USB device 403 into the memory 406, the data subjected to a CD-ROM correction, and stores only the user data of 2048 bytes into the memory 406.

Next, the reproduction operation of the data reproduction device 400 according to the second embodiment will be described.

First, the operation of reproducing data from the optical disc 401 which has recorded data in a CD-DA format or a CD-ROM format will be described.

In the optical disc 401, the data in a CD-DA format shown in FIG. 2 or the data in a CD-ROM format shown in FIG. 5 is recorded, and the output data from the pickup 402 is read out as reproduced data by the disc reading out part 404, and the reproduced data is sent out to the writing in control part 407. The writing in control part 407 which has received the reproduced data carries out, when performing reproducing of the optical disc 401, a control such that the data from the disc reading out part 404 is stored into the memory 406. Meanwhile, the writing control part 407 converts, when the data recorded in the optical disc 401 is in a CD-DA format, in order to ease the reading out control, the data of the format illustrated in FIG. 2 to the data of the format illustrated in FIG. 3 similarly as in the first embodiment, and writes in the reproduced data after its format being converted into the memory 406. Then, the data which is written in into the memory 406 is read out by the reading out control part 408, to be outputted as audio output. Further, the writing in control part 407 carries out, when the data recorded in the optical disc 401 is the data in a CD-ROM format, a CD-ROM correction processing, and writes in, in order to ease the reading out control, only the user data of 2048 bytes among the corrected data in the format illustrated as in FIG. 5. Then, the data which were written in into the memory 406 are read out to the reading out control part 408, and the read out data are subjected to the decoding processing by the compression decoder 409, to be outputted as audio output.

Next, the operation of reproducing the data in a CD-DA format or a CD-ROM format from the external USB device 403 will be described.

The external USB device 403 has recorded data in a block unit constituted as illustrated in FIG. 2 or in FIG. 5 similarly as the optical disc 401, and the reproduced data is taken in by the external data taking in part 405, to be sent out to the writing in control part 407. The writing in control part 407 which has received the reproduced data writes in, when performing reproduction of data from the external USB device 403, the data from the external data taking in part 405 into the memory 406. Meanwhile, the writing in control part 407 converts, when the data recorded in the external USB device 403 is the data in a CD-DA format, in order to ease the reading out control, the data format from the format illustrated in FIG. 2 to the format illustrated in FIG. 3 similarly as in the first embodiment, and writes in the reproduced data in the converted format into the memory 406. Then, the data which was written in into the memory 406 is read out by the reading out control part 408, to be outputted as audio output. In addition, when the data recorded in the external USB devise 403 is the data in the CD-ROM format, the wiring in control part 407 carries out a CD-ROM correction processing similarly as at performing reproduction from the optical disc 401, and writes, in order to ease the reading out control, only the user data of 2048 bytes among the correct data in the format as illustrated in FIG. 5. Then, the data which were written in into the memory 406 are read out by the reading out control part 408, and is decoded by the compression decoder 409, to be outputted as audio output.

In addition, when only the user data after being subjected to the CD-ROM error correction is stored in the external USB device 403, the user data is taken in by the external data taking in part 405, to be sent out to the writing in control part 407. When the reproduction of data from the external USB device 403 is carried out, the writing in control part 407 which has received the user data writes in the user data into the memory 406. Meanwhile, the writing in control part 407 is not needed to carry out a CD-ROM correction processing, and it carries out writing in of the data which is only the user data that is required into the memory 406 as it is. The data which are written in into the memory 406 are read out to the data reading out part 408, and then, it is subjected to decoding processing by the compression decoder 409, to be outputted as audio data.

Thus, in the data reproduction device of the second embodiment, the writing in of the reproduced data from the optical device 401 or the reproduced data from the external USB device 403 into the memory 406 is carried out by the writing in control part 407 in such a manner that the data storage formats on the memory 406 when performing the both writing in are the same storage formats with each other.

As described above, according to the data reproduction device of this second embodiment, the writing in of the reproduced data 401 from the optical disc 401 onto the memory 406 and the writing in of the reproduced data from the external USB device 403 into the memory 406 when performing reproduction of data in a CD-DA format, are carried out by the writing in control part 407 by similar methods, and further the writing in of the reproduced data from the optical disc 401 into the memory 406 and the writing in of the reproduced data from the external USB device 403 into the memory 406 when performing reproduction of data in a CD-ROM format, are carried out by the writing in control part 407 by similar methods including the CD-ROM correction processing together. Therefore, when realizing a data reproduction device having a function of reproducing data from the optical disc 401 and a function of reproducing data from the external USB device 403, the writing in control part 407 can be made common for the both writing in, and thereby the circuit can be made of high efficiency. In addition, when reproducing data in a CD-ROM format, the writing in control part 407 is operated to carry out, in both of reproduction of data from the optical disc 401 and reproduction of data from the external USB device 403, a control such that only the user data is stored into the memory 406 and the data storage formats are the same storage formats with each other. Therefore, even the operations of the reading out control part 408 and the writing in control part 409 can be carried out by similar methods at both of performing reproduction of data from the optical disc 401 and performing reproduction of data from the external USB device 403. In addition, since the writing in control and the reading out control can be carried out by similar methods at both of reproduction of data from the optical disc 401 and reproduction of data from the external device, the load to a microcomputer which controls the entire system can be reduced, and thereby a data reproduction device having a function of reproducing data from the disc 401 and a function of reproducing data from the external USB device 403 can be easily realized.

Further, when the external USB device has recorded therein the data after being subjected to a CD-ROM correction processing, the writing in control part 407 is only required to store the data from the external USB device as it is into the memory, thereby to provide a control such that the data storage formats in the memory 406 are the same storage formats with each other. Even in this case, the operation of the compression decoder 409 can be carried out by the similar methods with each other.

While in the above-described second embodiment an example in which an external USB device is employed is described, it is not limited thereto. That is, the present invention can be realized by a memory device including other storage medium (external medium) such as an SD memory card.

Further, in this second embodiment, a data reproduction device in which when reproducing data in a CD-DA format, data which was read out from the memory 406 by the reading out control part 408 is outputted as an audio output, and when the data in a CD-DA format is reproduced, the compressed data is read out from the memory 406 by the reading out control part 408 to be subjected to the compression decoding, is described. However, a construction in which only the data in a CD-ROM format may be provided.

Further, while in the second embodiment reproduction of data in a CD-DA format or in a CD-ROM model format is described, the reproduction of data in other formats such as a CD-ROM model format may be carried out with the same effects as described above.

Further, while in the second embodiment an example in which an optical disc is employed as a disc medium is described, a data reproduction device employing an optical magnetic disc, a magnetic disc, or the like may be constructed with the same effects as described above.

### Third Embodiment

A data reproduction device according to a third embodiment of the present invention will be described.

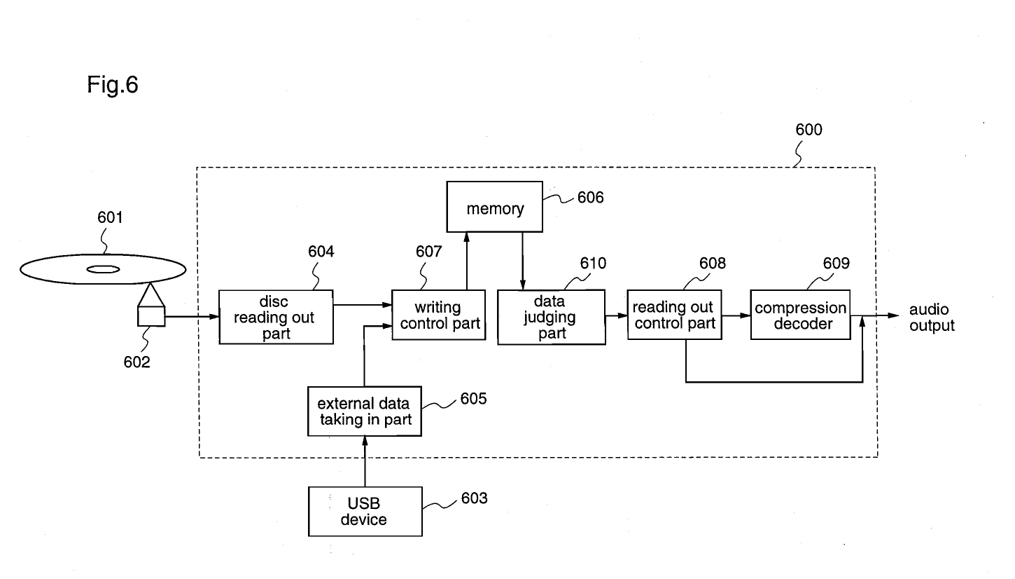

FIG. 6 shows a block construction diagram illustrating a data reproduction device according to the third embodiment of the present invention.

In FIG. 6, the data reproduction device 600 according to the third embodiment of the present invention includes an optical pickup 602 which collects a light beam onto an information surface of an optical disc (disc medium) 601 in which information symbols are recorded on spiral or concentric tracks to form a light beam spot and detects the reflected light to output respective kinds of information, an external USB device 603 (external device) in which audio reproduced data is stored, a disc reading out part 604 for reading out reproduced data on the basis of the information which is outputted from the optical pickup 602, an external data taking in part 605 for taking in reproduced data from the external USB device 603, a memory 606 for temporarily storing the data reproduced from the optical disc 601 or the data reproduced from the external USB device 603 for anti-earthquake use at performing reproduction from the disc, a writing in control part 607 for performing a control for writing of data into the memory 606 with switching as input between the reproduced data from the disc reading out part 604 and the reproduced data from the external data taking in part 605, a data judging part 610 for judging data as being the reproduced data from the optical disc 601 or being the reproduced data from the external USB device 603, a reading out control part 608 for switching the reading out control between the reproduced data from the optical disc 601 and the reproduced data from the external USB device 603 in accordance with the information from the data judging part 610, and a compression decoder 609 which makes the compressed audio data subjected to decoding processing to output the result as an audio data.

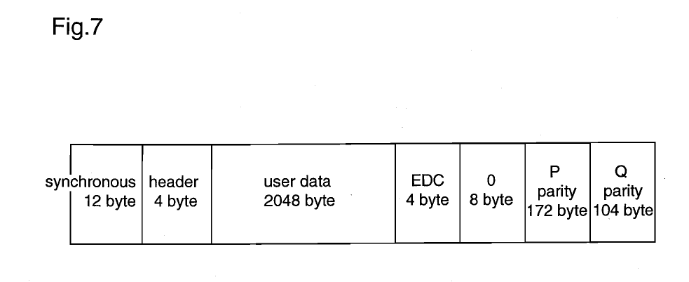

In the data reproduction device of the third embodiment, the reproduced data from the optical disc 601 and the external USB device 603 are supposed to be in a CD-ROM format. As this CD-ROM format, the format of CD-ROM model format is adopted as illustrated in the format of the 1 sub-coding frame shown in FIG. 7.

Next, the data reproduction operation of the data reproduction device of this third embodiment will be described.

First, the operation of reproducing data from the optical disc 601 which has recorded data in a CD-ROM format will be described.

In the optical disc 601, the data in a CD-ROM format as illustrated in FIG. 7 is recorded, and the output data from the pickup 602 is read out as reproduced data from the disc reading out part 604, and the reproduced data is sent out to the writing in control part 604. The writing in control part 607 which has received the reproduced data carries out, while performing reproduction from the disc, writing in of the data from the disc reading out part 604. Meanwhile, the writing in control part 607 performs a CD-ROM correction processing, and writes in only the user data of 2048 bytes among the data after being subjected to the correction in the format as illustrated in FIG. 7 into the memory 606. When reading out data which were written in into the memory 606, it is confirmed that the read out data are those which are stored as only the required data by the data judging part 610, thereby it is judged as being the reproduced data from the optical disc 601, and it is informed to the reading out control part 408 that it is the reproduced data from the optical disc 601. After the reading out control part 408 reads out only the required user data as the reproduced data from the disc, it makes the read out data subjected to the decoding processing by the compression decoder 609, to output only the required user data as it is as audio output.

Next, the operation of reproducing the data in a CD-ROM format from the external USB device 603 will be described.

The external USB device 603 has recorded therein data in a block unit as illustrated in FIG. 7 similarly as the optical disc 601, and the reproduced data is taken in by the external data taking in part 605, and the reproduced data is sent out to the writing in control part 607. The writing in control part 607 which has received the reproduced data writes in, when performing reproduction of data from the external USB device 605, the data from the external data taking in part 605 into the memory as it is. That is, it carries out a control such that writing in of data into the memory 606 is carried out in a block unit as illustrated in FIG. 7. When performing reading out of data which were written in into the memory 606, it is confirmed that the read out data is in the format illustrated in FIG. 7 by the data judging part 610, thereby enabling to judge that it is the reproduced data from the external USB device 603, and it is informed to the reading out control part 608 as being the reproduced data from the external USB device 603. The reading out control part 608 reads out data as reproduced data from the external USB device 603, and carries out a control such that only required data are taken in from the read out data, and thereby the taken in data are subjected to the decoding processing by the compression decoder 609, to be outputted as an audio output.

As described above, according to the data reproduction device of this third embodiment, when carrying out a writing in control of the reproduced data from the external USB device 603 into the memory 606 by the writing in control part 607 while reproducing data in a CD-ROM format, the data which is stored in the external USB device 603 is written in into the memory 606 as it is, and with being provided with a data judging part 610 which judges whether the read out data is the data from the disc 601 or the data from the external USB device 603 dependent on the format of the data read out from the memory 606, taking in of only the required data is carried out by the reading out control part 608. Therefore, when realizing a data reproduction device having a function of reproducing data from the optical disc 601 and a function of reproducing data from the external USB device 603, there is no necessity of giving an excessive load to the writing in control by the writing in control part 607, and further, the reading out control by the reading out control part 608 can be easily carried out based on the judgment result from the data judging part 610. Further, in a system which carries out the reading out control by another processor, the load to the microcomputer which performs the writing in control can be shared with the other processor, thereby providing a system of high efficiency.

While in the above-described third embodiment an example in which an external USB device is employed is described, it is not limited thereto. That is, it can be realized by a memory device including other storage medium (external medium) such as an SD memory card.

Further, while in the third embodiment the model format is described as a format for CD-ROM format, a CD-ROM mode2 format, a CD-DA format, or other format may be employed with the same effects as described above. Further, when the data in a CD-DA format is reproduced, the reproduced data that is read out by the reading out control part 608 is outputted as audio output without passing through the compression decoder 609, similarly as in the second embodiment.

Further, while in the third embodiment a case where an optical disc is employed as a disc medium is described, a data reproduction device employing an optical magnetic disc, a magnetic disc, or the like may be constructed with the same effects described above.

### Fourth Embodiment

A data reproduction device according to a fourth embodiment of the present invention will be described.

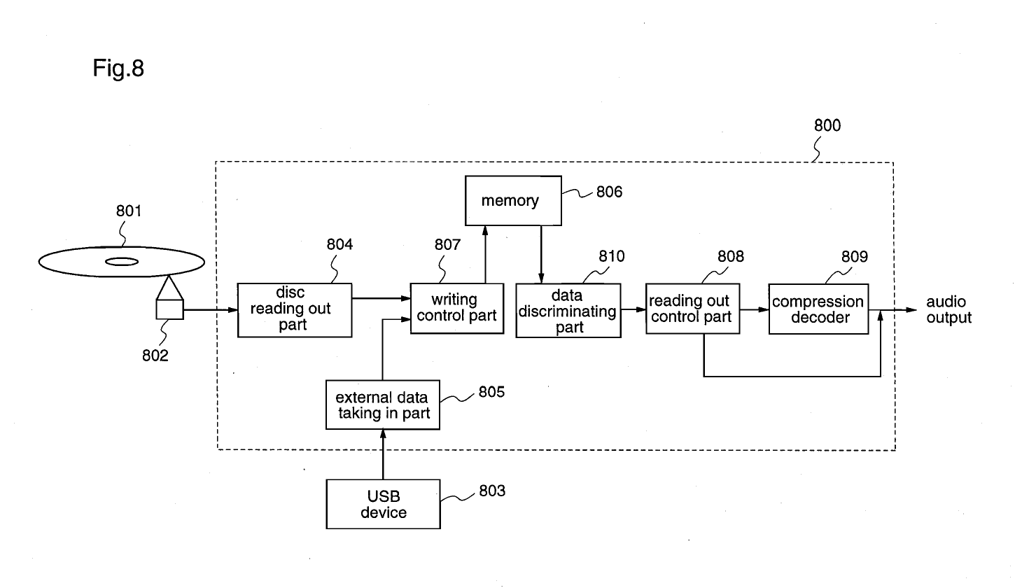

FIG. 8 shows a block construction diagram according to the fourth embodiment of the present invention.

In FIG. 8, the data reproduction device 800 of this fourth embodiment includes an optical pickup 802 which collects a light beam onto an information surface of an optical disc (disc medium) 801 in which information symbols are recorded on spiral or concentric tracks to form a light beam spot and detects the reflected light to output respective kinds of information, an external USB device 803 in which audio reproduced data is stored, a disc reading out part 804 for reading out reproduced data on the basis of the information which is outputted from the optical pickup 802, an external data taking in part 805 for taking in the reproduced data from the external USB device 803, a memory 806 for temporarily storing the data reproduced from the optical disc 801 or the data reproduced from the external USB device 803 for anti-earthquake use at performing reproduction from the disc, a writing in control part 807 for performing a control for writing of data into the memory 806 with switching as input between the reproduced data from the disc reading out part 804 and the reproduced data from the external data taking in part 805, a data judging part 810 for judging data as being the reproduced data from the optical disc 801 or being the reproduced data from the external USB device 803, a reading out control part 806 for switching a reading out control between for the reproduced data from the optical disc 801 and for the reproduced data from the external USB device 803 on the basis of the information from the data judging part 810, and a compression decoder 809 which makes the compressed audio data subjected to decoding processing to output the result as an audio data.

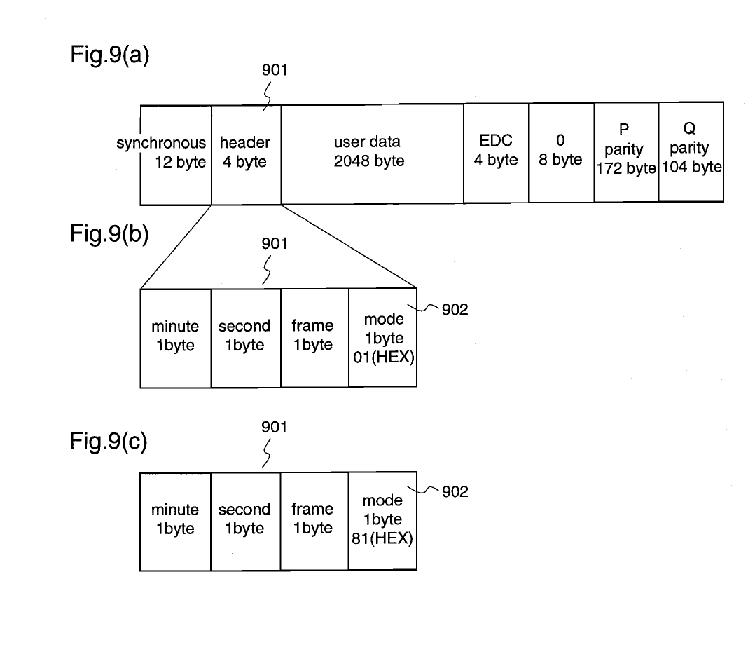

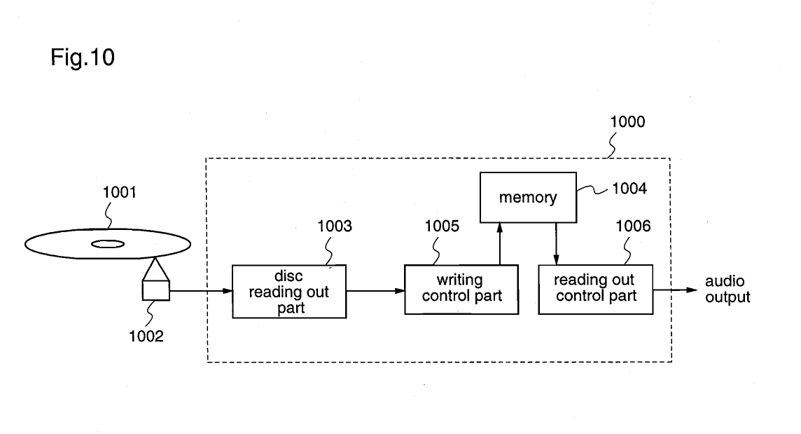

In the data reproduction device of this fourth embodiment, the reproduced data which is read out from the optical disc 801 and from the external USB device 803 are both supposed as data in a format of CD-DA format. The CD-ROM format is supposed as the format of CD-ROM model format as illustrated in the format of one sub coding frame shown in FIG. 9(a). Further, the four bytes of the header part 901 shown in FIG. 9(a) are constituted by the information 902 comprising respective one bit information of minute, second, and frame, and a bit indicating the mode, as shown in FIG. 9(b). As for the one byte indicating the mode, “1” is recorded for the model while “2” is recorded for the mode2. In this fourth embodiment, “1” is recorded.

Further, the writing in control part 807 replaces, when performing writing in of the reproduced data in a CD-ROM format that is reproduced from the external USB device 803 into the memory 806, the uppermost bit among 1 byte information 902 of the header part 901 which bit indicates the mode as an identification information for the reproduced data from the external USB device 803, with “1” as shown in FIG. 9(c). Further, the writing in control part 807 carries out storage of the reproduced data in a CD-DA format from the optical disc 801 into the memory 806, in a state of the header part 901 being as shown in FIG. 9(b), i.e., a state where the uppermost bit of the 1 byte information 902 which indicates the mode is “0”.

Next, the reproduction operation of the data reproduction device 800 according to the fourth embodiment of the present invention will be described.

First, the operation of reproducing the data from the optical disc 801 which has recorded data in a CD-DA format will be described.

In the optical disc 801, the data in a construction as illustrated in FIGS. 9(a) and 9(b) is recorded, and the output data from the pickup 802 is read out as reproduced data by the disc reading out part 804, and the reproduced data is sent out to the writing in control part 807. The writing in control part 807 which has received the reproduced data carries out writing in, when reproducing data from the optical disc 801, of the data from the disc reading out part 804 in the format illustrated in FIGS. 9(a) and 9(b) as they are into the memory 806. When performing reading out of the data which has been written in into the memory 806, it is confirmed that the uppermost bit of the information 902 indicating the mode in the header 901 is “0”, and it is informed to the reading out part 808 that it is the reproduced data from the optical disc 801. The reading out control part 808 carries out a control such as a CD-ROM correction processing, and against the data after being corrected, only the required user data is taken out, and the decoding of the user data that is taken out by the compression decoder 809 is carried out, to output the result as an audio output.

Next, the operation of reproducing the data in a CD-ROM format from the external USB device 803 will be described.

The external USB device 803 has recorded therein the data as illustrated in FIGS. 9(a) and 9(b) similarly as the optical disc 801, and the reproduced data is taken in by the external data taking in part 805, and the reproduced data is sent out to the writing in control part 807. The writing in control part 807 which has received the reproduced data carries out conversion, when reproducing data from the external USB device 803, of the data from the external data taking in part 805 into the data of the format illustrated in FIG. 9(c), and writes in the result into the memory 806. Then, when performing reading out of the data which has been written in into the memory 806, it is confirmed that the uppermost bit of the information 902 in the header 901 indicating the mode is “1” by the data judging part 810, and it is informed to the reading out control part 808 that the data is the reproduced data from the external USB device. The reading out control part 808 carries out reading of data as the data being from the external USB device 803, carries out such as a CD-ROM correction processing, and takes in only the required user data to carry out decoding of the taken in user data by the compression decoder 809 to output the result as an audio output.

Further, when only the user data after being subjected to the CD-ROM correction is stored into the external USB device 803, the user data is taken in by the external data taking in part 805, and the user data is sent out to the writing in control part 807. When the reproduction of data from the external USB device 803 is carried out, the writing in control part 807 which has received the user data carries out writing in of that data into the memory 806 with that user data including an identification information. When it is informed to the reading out control part 808 that the data is the data reproduced from the external USB device 803, the reading out control part carries out reading out of the data as the reproduced data from the external USB device 803 to take in only the required user data, and makes the taken in user data subjected to the decoding by the compression decoder 809, to output the result as an audio output.

As described above, according to the data reproduction device of this fourth embodiment, when reproducing data in a CD-ROM format, a control is carried out by the writing in control part 807 such that the storage of the data which is reproduced from the optical disc 801 into the memory 806 is carried out with keeping the format of the data as it is, while the storage of the data which is reproduced from the external USB device 803 into the memory 806 is carried out with converting the format of the data into the format including an identification information, and further whether the data is the data reproduced from the optical disc 801 or the data reproduced from the external USB device 803 is judged by the data judging part 801 with confirming the uppermost bit of the information 902 indicating the mode in the header 901, and the outputting of the audio data is controlled by the reading out control part 808 on the basis of the judgment result. Therefore, the judgment of the reproduced data can be carried out easily by the writing in control part 808, and the load to the reading out control can be reduced.

While in the fourth embodiment an example in which an external USB device is employed is described, it is not limited thereto. That is, the present invention can be realized by a memory device including other storage medium (external medium) such as an SD memory card.

In addition, while in the fourth embodiment the model format is described as a format for CD-ROM format, a CD-ROM mode2 format, a CD-DA format, or other format may be employed with the same as described above. Further, when the data in a CD-DA format is reproduced, the reproduced data that is read out by the reading out control part 808 is outputted as audio output without passing through the compression decoder 809, similarly as in the second embodiment.

In addition, while in the fourth embodiment the information 902 indicating the mode in the header 901 in the CD-DA format is converted into an identification information, this is not limited thereto. That is, other data portion may be replaced into an identification information, or an identification information may be added thereto with the same effects as described above. Further, while the above-described fourth embodiment was constituted in a hardware construction, it may be constituted in a software construction with the same effects as described above.

Further, while in the fourth embodiment a case where an optical disc is employed as a disc medium is described, a data reproduction device employing an optical magnetic disc, a magnetic disc, or the like may be constructed with the same effects described above.

In addition, while in the fourth embodiment the writing in control part 807 stores the data as it is when reproducing the data from the optical disc 801 and stores the data reproduced from the external USB device 803 with converting the format of the reproduced data into the format including an identification information, it is not limited thereto. That is, the writing in control part may store the data from the optical disc 801 with converting the format of the reproduced data into the format including an identification information when reproducing the data from the optical disc while store the data from the external USB device 803 with keeping the format of the reproduced data as it is in the memory 806. Alternatively, the data from the optical disc and the data from the external USB device 803 may be converted respectively into the formats which include an identification information respectively.

### APPLICABILITY IN INDUSTRY

The data reproduction device of the present invention is effective as a data reproducing device which has a function of reproducing data which is recorded on a disc such as CD-ROM, CD-R, and CD-RW, and a function of reproducing data which is recorded in an external storage medium such as a USB device or an SD card.

The data reproduction device of the present invention can be also applied to an optical magnetic disc or a magnetic disc.

The data reproduction device of the present invention can be applied not only to a storage medium but to a reproduction use for a recording medium in which reproduction data is recorded.

1. A data reproduction device which has a function of reproducing data which is recorded in a disc medium, and a function of reproducing data which is recorded in an external medium other than the disc medium or reproducing data from an external device, comprising:
a disc reading out part for reading out data which is recorded in the disc medium,
an external data taking in part for taking in data from the external medium or the external device,
a memory for temporarily storing the reproduced data from the disc medium which was read out by the disc reading out part, or the reproduced data from the external medium or the external device which has been taken in by the external data taking in part,
a writing in control part for writing in the reproduced data from the disc medium which is read out by the disc reading out part, or the reproduced data from the external medium or the external device which has been taken in by the external data taking in part into the memory, and
a reading out control part for reading out the reproduced data which has been written in into the memory, wherein
the writing in control part carries out the writing in of the reproduced data from the disc medium or the reproduced data from the external medium or the external device into the memory in such a manner that the data storage formats on the memory while performing the both writing in are the same storage formats with each other.

2. A data reproduction device as defined in claim 1, wherein
the writing in control part writes in only the user data in the format of compressed data when performing writing in of the reproduced data into the memory in a case where the reproduced data which was recorded in the external medium or the external device is in the format of compressed data, and
a compression decoder which decodes the compressed data, when the compressed data is read out from the memory in which the compressed data is written in, to output the decoded data as reproduced data, is provided.

3. A data reproduction device which has a function of reproducing data which is recorded in a disc medium, and a function of reproducing data which is recorded in an external medium other than the disc medium, or reproducing data from an external device, comprising:
a disc reading out part for reading out data which is recorded in the disc medium,
an external data taking in part for taking in data from the external medium or the external device,
a memory for temporarily storing the reproduced data from the disc medium which was read out by the disc reading out part, or the reproduced data from the external medium or the external device which has been taken in by the external data taking in part,
a writing in control part for writing in the reproduced data from the disc medium which is read out by the disc reading out part, or the reproduced data from the external medium or the external device which has been taken in by the external data taking in part into the memory,
a reading out control part for reading out the reproduced data which has been written in into the memory, and
a data judging part which judges the read out data from the disc reading out part and the reproduced data from the external device or the external medium when performing reading out of the reproduced data which was written in into the memory, wherein
the reading out control part carries out the reading out of the data with selecting only the required user data when the data to be read out is judged as the reproduced data from the external device or the external medium by the data judging part.

4. A data reproduction device as defined in claim 3, wherein
the writing in control part writes in the reproduced data from the disc medium or the reproduced data from the external medium or the external device with containing an identification information for the reproduced data in the reproduced data, and
the reading out control part carries out reading out of the reproduced data in accordance with the judgment result as to whether the reproduced data that is judged on the basis of the identification information is the reproduced data from the disc medium or the reproduced data from the external medium or the external device.
